(19) United States
(12) Patent Application Publication
(10) Pub. No.: US 2013/0124889 A1
(43) Pub. Date: May 16, 2013

(54) METHOD AND SYSTEM OF CONTROLLING POWER CONSUMPTION OF AGGREGATED I/O PORTS

(71) Applicant: Ajitkumar A. Natarajan, Campbell, CA (US)

(72) Inventor: Ajitkumar A. Natarajan, Campbell, CA (US)

(21) Appl. No.: 13/808,622

(22) PCT Filed: Jul. 30, 2010
(86) PCT No.: PCT/US10/43816

§ 371 Date: Jan. 7, 2013

(51) Int. Cl. G06F 1/32

(52) U.S. Cl. CPC G06F 1/3234
USPC 713/320; 713/300

(57) ABSTRACT

Controlling power consumption of aggregated I/O ports. At least some of the illustrative embodiments are methods that include: aggregating a plurality of input/output (I/O) ports; and controlling power consumption in the computer system. Controlling the power consumption includes: sending a command from a power policy management program to an aggregation software executing in the computer system, the aggregation software implements the aggregating; and changing a power consumption mode of at least one of the I/O ports responsive to the command.

### BACKGROUND

In the operation of large data centers, comprising many tightly-packed server computer systems each dissipating hundreds of watts of power, maintaining temperature is a major concern and expense. In many cases, the cost of equipment to control temperature within the data center may meet or exceed the cost of the server equipment. Because of the concerns and costs regarding temperature, as well as a push to conserve energy, computer system manufacturers implement power reduction techniques.

The bulk of the power reduction techniques have focused on the processors and memory of the servers. For example, during periods of time when processing load is low, the one or more processors of a server may be operated in a lower power consumption mode (e.g., at a reduced clock frequency). Likewise, during periods of time when processing load is or is expected to be low, portions of the main memory may have their contents relocated, and the portions of the main memory powered-off.

Any system or technique which may further reduce the power consumption of a server would provide a competitive advantage in the marketplace.

### BRIEF DESCRIPTION OF THE DRAWINGS

For a detailed description of exemplary embodiments, reference will now be made to the accompanying drawings in which:

FIG. 1 shows a computer system in accordance with at least some embodiments;

FIG. 2 shows the functional relationship between various sets of executable instructions and I/O ports in accordance with at least some embodiments; and

FIG. 3 shows a method in accordance with at least some embodiments.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . . ” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical connection, or through a wireless connection.

“Power consumption mode” shall refer to a device's mode of operation that sets an upper limit to the amount of power the device may consume when being utilized, but shall not refer to a state of utilization of the device. For example, a device operating in a “fully on” power consumption mode shall be considered to be in the “fully on” power consumption mode whether the device is being utilized at its full potential (and drawing higher power) or the device is not being utilized at all (and drawing lower power). Stated otherwise, power usage changes based on mere changes in utilization of a device shall not be considered a change in power consumption mode.

“Aggregating” and “aggregation” shall mean, with respect to input/output (I/O) ports a communication network, that the I/O ports appears as a single logical I/O port to a software stack. “Aggregating” and “aggregation” shall mean, with respect to I/O ports of a storage network, that the I/O ports represent redundant paths to a storage device.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

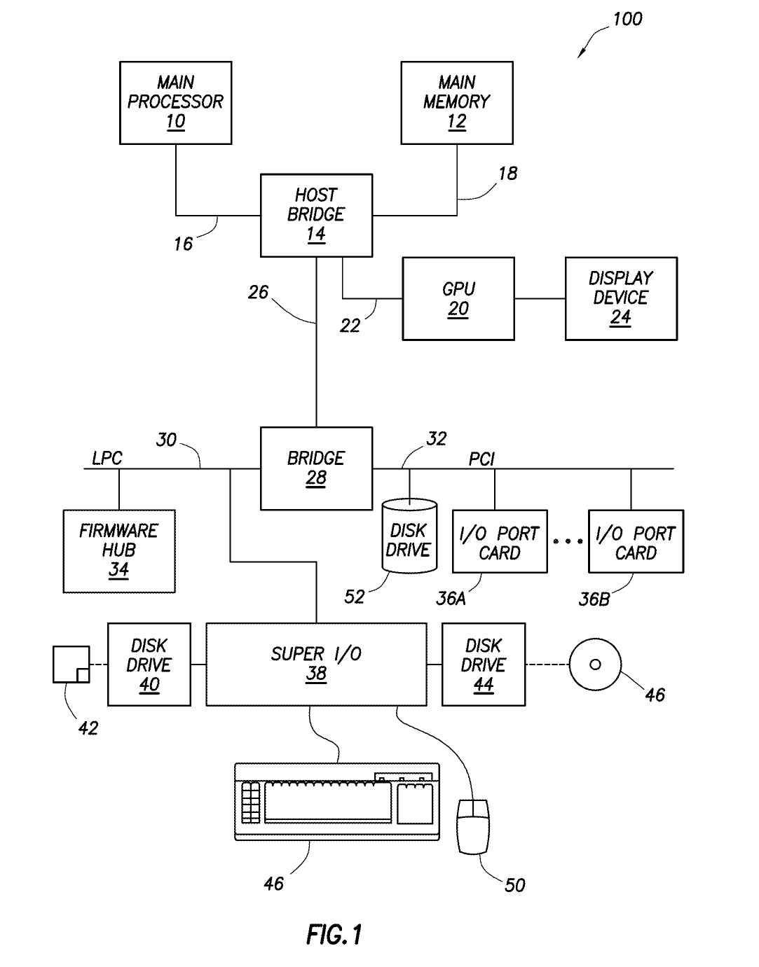

FIG. 1 illustrates a computer system 100 in accordance with at least some embodiments. In particular, computer system 100 comprises a main processor 10 coupled to a main memory array 12, and various other peripheral computer system components, through integrated host bridge 14. Computer system 100 may implement multiple main processors 10. The main processor 10 couples to the host bridge 14 by way of a host bus 16, or the host bridge 14 may be integrated into the main processor 10. Thus, the computer system 100 may implement other bus configurations or bus-bridges in addition to, or in place of, those shown in FIG. 1.

The main memory 12 couples to the host bridge 14 through a memory bus 18. Thus, the host bridge 14 comprises a memory control unit that controls transactions to the main memory 12 by asserting control signals for memory accesses. In other embodiments, the main processor 10 directly implements a memory control unit, and the main memory 12 may couple directly to the main processor 10. The main memory 12 functions as the working memory for the main processor 10 and comprises a memory device or array of memory devices in which programs, instructions and data are stored. The main memory 12 may comprise any suitable type of memory such as dynamic random access memory (DRAM) or any of the various types of DRAM devices such as synchronous DRAM (SDRAM), extended data output DRAM (EDODRAM), or Rambus DRAM (RDRAM). The main memory 12 is an example of a non-transitory computer-readable medium storing programs and instructions, and other examples are disk drives and flash memory devices.

In some embodiments, text and video generated by software executing on the processor 10 is provided to a graphics processing unit (GPU) 20 coupled to the host bridge 14 by way of an Advanced Graphics Port bus 22, PCI-Express, or other suitable type of bus. Alternatively, the display driver device could couple to the primary expansion bus 26 or one of the secondary expansion buses (i.e., the peripheral component interconnect (PCI) bus 32). The display device 24 to which the graphics processing unit 20 couples may comprise any suitable electronic display device upon which any image or text can be represented. In embodiments where the computer system 100 is a server system (e.g., in a rack mounted enclosure with a plurality of other server systems), the graphics processing unit 20 and display device 24 may be omitted.

Still referring to FIG. 1, the illustrative computer system 100 also comprises a second bridge 28 that bridges the primary expansion bus 26 to various secondary expansion buses, such as a low pin count (LPC) bus 30 and peripheral components interconnect (PCI) bus 32. Various other secondary expansion buses may be supported by the bridge device 28, such as Universal Serial Bus (USB). However, computer system 100 is not limited to any particular chip set manufacturer, and thus bridge devices and expansion bus protocols from any of a variety of manufacturers may be equivalently used.

Firmware hub 34 couples to the bridge device 28 by way of the LPC bus 30. The firmware hub 34 comprises read-only memory (ROM) which contains software programs executable by the main processor 10. The software programs comprise programs executed during and just after power on self tests (POST) procedures as well as memory reference code. The POST procedures and memory reference code perform various functions within the computer system before control of the computer system is turned over to the operating system.

The computer system 100 further comprises a plurality of input/output (I/O) port devices 36 illustratively coupled to the PCI bus 32. The I/O port device 36 couple to one more network types. For example, in a particular embodiment, the I/O port devices 36 are network interface cards (NIC), which couple the computer system 100 to a communication network, such as a local area network (LAN), wide area network (WAN), and/or the Internet. In yet still other embodiments, the I/O port devices are storage adapter cards which couple the computer system 100 to one or more remotely located long term storage devices (e.g., hard drives, optical drives) by way of a storage network (e.g., Fibre Channel). Other types of I/O port devices may be equivalently used. While FIG. 1 illustrates both I/O port devices 36 coupled to the same PCI bus 32, in other embodiments the I/O port devices 36 may couple to different PCI buses, or buses having different communication protocols (e.g., one I/O port card coupled to the PCI bus, and a second I/O port device coupled to the primary expansion bus).

Still referring to FIG. 1, computer system 100 may further comprise a Super I/O controller 38 coupled to the bridge 28 by way of the LPC bus 30. The Super I/O controller 38 controls many computer system functions, for example interfacing with various input and output devices such as a “floppy” disk drive 40 and “floppy” disk 42, optical disk drive 44 and optical disk 46, keyboard 48, and pointing device 50 (e.g., mouse). The super I/O controller 38 is often referred to as “super” because of the many computer system functions which is performs.

The computer system 100 may further comprise a long term data storage device, such as disk drive system 52 coupled to the bridge 28 by way of the illustrative PCI bus 32 (the bus adapter not shown so as not to unduly complicate the figure). The disk drive system 52 may be a single drive, or an array of drives operated as a redundant array of independent (or inexpensive) disks (RAID) system. While the illustrative disk drive system 52 is shown as coupled to the PCI bus 24, the disk drive system may equivalently couple to other buses, such as the primary expansion bus 26 or other secondary expansion buses.

Each I/O port device 36 implements at least one communication port, and each I/O port device 36 may implement multiple communication ports. For example, in the illustrative case of an I/O port device 36 in the form of a NIC may implement four or eight communication ports, and thus may implement four or eight separately controllable interfaces. As yet another example, in the illustrative case of an I/O port device 36 in the form of a storage adapter card, each storage adapter may implement four or eight communication ports, and thus may implement four or eight separately controllable interfaces to remotely located storage. In accordance with the various embodiments, two or more ports may be grouped, teamed or aggregated for purposes of fault tolerance and/or to increase communication throughput. Aggregated ports may be implemented on the same I/O port devices, or the ports may span multiple I/O port devices. Moreover computer system 100 may implement multiple aggregated teams.

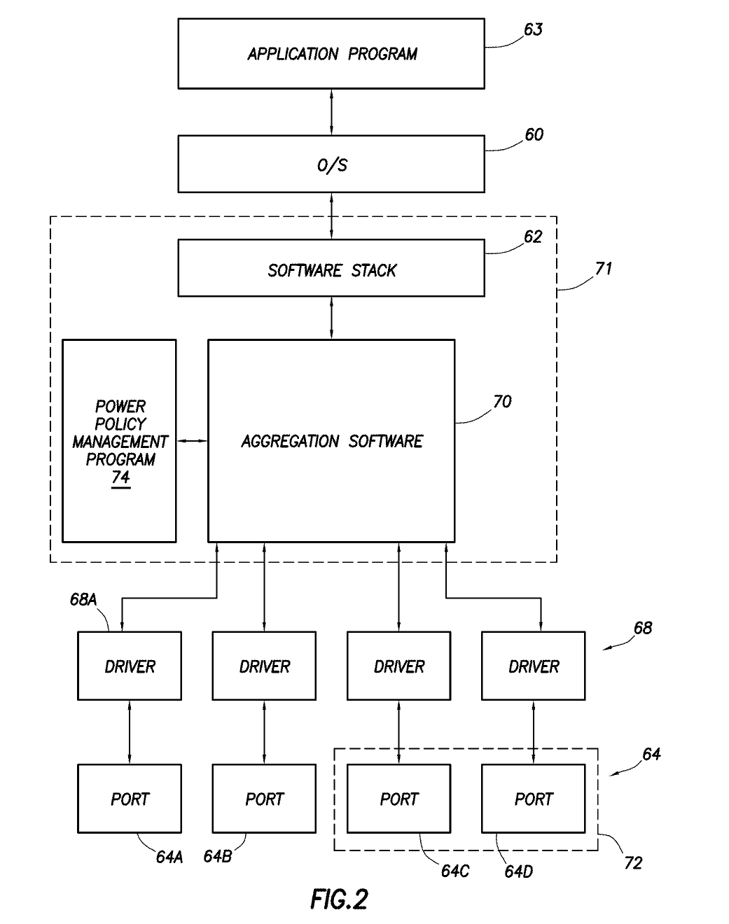

FIG. 2 shows an illustrative relationship of various pieces of software executed by the processor 10 to implement aggregation in accordance with at least some embodiments. In particular, the computer system implements an operating system (O/S) 60 that supports remote communications. Any currently available or after developed operating system that supports remote communications may be used. In the illustrative case of FIG. 2, the operating system 60 supports a software stack 62. In cases where the I/O port devices 36 are communications network interface devices, the software stack 62 may be a transmission control protocol/internet protocol (TCP/IP) stack, but other communication protocols may be implemented simultaneously or in the alternative (e.g., IPX, NetBEUI). In cases where the I/O port devices 36 are storage network devices, the software stack 62 is a storage network stack, such as a SCSI stack. The operating system 60, and in particular the illustrative software stack 62, enable one or more application programs 63 to communicate to, for example, other computer systems over a network and/or to remotely located storage devices.

Each port 64 has associated therewith a driver 68 (in some cases, each individual driver may be alternatively referred to a miniport driver). In cases where each I/O port device 36 is made by the same vendor and have the same capabilities, the drivers 68 may be duplicate programs. However, the I/O port devices need not be made by the same vendor or have the same capabilities. For example, in the case of I/O port devices 36 being NICs, one NIC may implement 100 megabit per second (Mbps) data throughput, while another NIC may implement 1000 Mbps (Gigabit) throughput, and in these alternative embodiments the drivers may be vendor and/or capability specific. In spite of having different vendors and/or different capabilities, the various I/O port devices, or their ports, may still be aggregated in accordance with embodiments of the invention.

In situations where each port 64 operates independently, the illustrative stack software 62 communicates directly with each driver 68; however, in accordance with the various embodiments the ports 64 are aggregated. To enable aggregation, aggregation software 70 interfaces between the illustrative software stack 62 and the various drivers 68. Although FIG. 2 shows the software stack 62 and aggregation software 70 as separate pieces of software, in some cases, the functionality may be combined in a single program, as illustrated by dashed line 71. More particularly in the case of communication networks, aggregation software 70 communicates with the software stack 42 and presents to the software stack a single logical port (i.e., looks like a single driver) for each group of aggregated ports. Likewise in the case of communication networks, aggregation software 70 appears as software stack to each of the drivers 68. In the case of the I/O port devices being NICs, several commercially available aggregation software products are available, such the Auto-Port Aggregation (APA) LAN monitor software available from Hewlett-Packard Company of Palo Alto, Calif.

In the case of storage networks, aggregation comes in the form of I/O ports that are redundant links to an end-storage device. For redundant links to a storage device, the storage communication may be sent out any of the aggregated ports, and yet still arrive at the end-storage device. It follows that in the illustrative case of FIG. 2 where all the I/O ports 64 are aggregated, storage communications can be sent out any of the I/O ports 64 and yet still arrive at the particular end-storage device (e.g., hard drive). In the case of storage networks, the software stack 62 may be aware of the redundant links represented by the aggregated I/O ports 64, but the aggregation software 70 makes decisions regarding which of the I/O ports out which the storage communication flows, and thus performs the aggregation function. Here again, while illustrative FIG. 2 shows the software stack 62 and aggregation software as separate pieces of software, the functionality could be combined into a single program, as illustrated by dashed line 71.

However, in addition to aggregation of the ports 64, the aggregation software 70 in accordance with the various embodiments also performs tasks in relation to power management at the I/O port level. Before delving into the power management functionality, and for a better understanding of the various embodiments, the specification first describes the shortcomings of power management of the related art.

In situations where the ports 64 operate independently (i.e., no teaming or aggregation), some related-art systems implement power saving features that operate based on inactivity of the port. For example, if a port is idle for a predetermined amount of time, the port may be placed into a lower power consumption mode by its respective driver. However, the decisions regarding power consumption mode in the related art are not coordinated across the ports. Moreover, in situations where the ports are teamed or aggregated, making a power consumption mode change with respect to a single port may be detrimental to the overall operation. Consider a situation where one port is acting as a primary port (out which all communications are sent and through which all communications are received), and a second port acting as a hot standby. If the second port is placed in a reduced power consumption mode based on inactivity, the second port will not have the ability to quickly and seamlessly carry load in the event the primary port fails. Because of the inability to apply coordinated control across teamed or aggregated ports, the related art devices do not implement power consumption mode control in such situations (i.e., the power consumption mode control is turned off, and the ports run at the peak power consumption mode at all times).

In accordance with the various embodiments, the aggregation software 70, in addition to implementing the aggregation policy for the ports 64, also implements coordinated control of the power consumption mode of each of the I/O ports 64, with the power consumption mode control dependent upon the type of aggregation implemented. The specification first turns a description of power consumption mode (and related peak power state), then to power consumption mode control in situations termed herein “active-standby,” followed by power consumption mode control in situations termed herein “active-active.”

An I/O port device has various power consumption modes. In illustrative cases where the ports 64 are implemented on I/O port devices 36 that couple to the computer system components by way of a PCI bus, the possible power consumption modes comprise D0 “fully-on” mode, the D3ₕₒₜ “off” mode, and two intermediate power consumption modes D1 and D2. Moreover, under the PCI Express (PCIe) Dynamic Power Allocation (DPA) standard, the D0 mode has several sub-states, where each sub-state defines a tradeoff between power consumed, performance and/or other characteristics. Each power consumption mode may have a different peak power state. For example, the illustrative D0 “fully-on” mode has a first peak power state, and the illustrative D2 intermediate mode has a second peak power state where the second peak power state is lower than the first peak power state. The lower peak power state may be implemented by any of a variety of operational techniques, such as lower clock rates for circuits on the I/O port device, reduced communication frequency by the I/O port device, and reduced usage of memory by the I/O port device. Thus, for devices being utilized to the full potential of their power consumption mode, a change in power consumption mode results in a change in power consumption.

While each power consumption mode has a peak power state, a device need not be operating at the peak power state—the peak power state is merely the peak power that may be drawn based on utilization in the particular mode. For example, a device operating in the illustrative D0 “fully-on” state, but which device is not being utilized, draws a particular amount of power to keep the various circuits on the device active, but draws or dissipates less power than if the device is being fully utilized. However, even for devices not being utilized, a change in power consumption mode may result in lower power usage. For example, an idle device whose power consumption mode is changed from an illustrative D0 “fully-on” to a D3ₕₒₜ “off” state will draw less power in the D3ₕₒₜ “off” state than the D0 “fully-on,” even though no change in utilization has occurred. For the balance of this specification, reference to a change in power consumption mode implicitly includes a change in the peak power state, again with the understanding that a power change may come from either a changed utilization (when operating at the limits of the power consumption mode), a changed power consumption even in the absence of full utilization for the particular mode, or both.

Ports 64 operated in the illustrative active-standby mode represent situations where the ports 64 are aggregated, and appear as a single port to the software stack 62 by operation of the aggregation software 70. However, in active-standby mode one port (e.g., port 64A) is designated as the primary port, and the remaining ports (e.g., ports 64B-64D) are designated as secondary ports. The illustrative primary port 64A sends and receives all communications, and the remaining ports operate as standby ports, ready to take over the duties as primary port in the event of the failure of the primary port. In order to quickly and seamlessly take over the duties as primary port, a secondary port is operated in a power consumption mode where, with little or no delay, the port can take over for a failed primary port (i.e., hot standby).

In accordance with embodiments operated in the active-standby mode, the aggregation software 70 implements a power control policy across all the aggregated ports that does not adversely affect the active-standby operational mode. For example, consider a situation where all the ports 64 are in their highest power consumption mode, and where port 64A is the primary port. If the aggregation software 70 decides or is commanded to reduce power consumption of the ports 64, the aggregation software 70 may select one of the ports to be the sole hot standby port (e.g., port 64B). More than one hot standby port is also contemplated, but for convenience the discussion assumes a single hot standby port. The selected hot standby is left in a power consumption mode where communication can be quickly and seamlessly taken over by the hot standby. Stated otherwise, the aggregation software 70 refrains from changing the power consumption mode of the primary port and the hot standby port. The remaining ports (e.g., ports 64C and 64D) are placed in a reduced power consumption mode. In the illustrative case of PCI devices implementing the ports 64, the primary port 64A and hot standby port 64B are both placed or left in the D0 “fully-on” mode, while the remaining ports 64C and 64D are placed in a reduced power consumption mode (e.g., D3ₕₒₜ “off” mode).

If further power reduction is desired in the illustrative active-standby case, and data communications throughput reductions can be tolerated, the aggregation software 70 may change the power consumption mode of the primary port 64A and hot standby port 64B (e.g., a sub-state of D0).

In the event of a failure of the primary port, the aggregation software 70 sets the hot standby as the primary port; additionally, the aggregation software 70, aware of the power policy for the active-standby situation, may select another (non-failed) port and raise the power consumption mode of the selected port to become the new hot standby. For example, upon the failure of the initial primary port 64A, the aggregation software sets the port 64B to the primary port, selects another port (e.g., port 64C) to be the hot standby port, and places the new hot standby is port 64C in a proper power consumption mode for hot standby operations. In some cases, the proper power consumption mode for the hot standby port will be the same power consumption mode as the primary port.

Still referring to FIG. 2, the specification now turns to the illustrative active-active mode of operation of the ports. Ports 64 operated in the illustrative active-active mode represent situations where the ports 64 are aggregated, and appear as a single port to the software stack 62 by operation of the aggregation software 70. However, in active-active mode each port participates in communication with a network to which the ports attach. For example, in the illustrative case of the ports implementing communication to a storage network, each port 64 takes an active role in the communication to network-attached storage devices. Likewise in the illustrative case of the ports implementing communication to a communications network, each port takes an active role in the communications. The active role, however, need not be the same across all the ports. For example, in the illustrative case of the ports 64 implementing communication to a communications network, one port (e.g., port 64A), may both send and receive message packets, and the remaining ports (e.g., ports 64B-64D) may only send message packets from the network. In yet still further situations, each port 64 may both send and receive message packets.

Regardless of the precise mechanism implemented in the active-active mode, the aggregation software 70 implements a power control policy across all the aggregated ports that does not adversely affect the active-active operational mode. For example, consider a situation where all the ports 64 are in their highest power consumption mode and all the ports are participating in some form in communications to the network. If the aggregation software 70 decides or is commanded to reduce power consumption of the ports 64, the aggregation software 70 reduces power consumption by lowering the power consumption mode or power states of one or more ports 64. In one case, the aggregation software may uniformly reduce the power consumption mode of all the ports 64. For example, the aggregation software may change the power consumption mode of all the ports from the D0 “fully-on” mode to one of the sub-states of D0.

However, reducing power in the active-active modes need not be a uniform reduction in power consumption mode. For example, in some cases the aggregation software may reduce the power consumption mode on a smaller subset of the aggregated ports 64 to implement the power reduction. For example, in cases where one port both sends and receives message packets (e.g., port 64A), and the remaining ports are used as send-only (e.g., ports 64B and 64C), the aggregation software may reduce the power consumption mode of one or more of the send-only ports to reduce power consumption. In some cases, the reducing of power consumption mode includes placing a port in an off state.

In addition to reducing power, the aggregation software 70 may also be responsible for increasing power. For example, the aggregation software 70 may decide or be commanded to increase available communication capacity based on actual or expected increase in communication load. The aggregation software 70 may raise the power consumption mode in advance of expected utilization increases, such as busy times of the day of web servers for ports 64 being communication network ports, or expected times of the day when large data backups are expected for ports 64 being storage network ports. Much like the reduction of power consumption mode, increases in power consumption mode could be uniformly applied (e.g., all ports placed in the D0 “fully on” mode), or non-uniformly applied.

What is more, the aggregation software 70 may take into account port specific parameters in both the active-active and active-standby illustrative modes. As mentioned above, the ports 64 may be implemented one each on I/O port device, multiple ports may be implemented on a single I/O port device, and the I/O port devices need not be of the same manufacturer, make or model. In these embodiments, the aggregation software 70 may make power consumption mode changes taking into account the specific parameters. Consider, as an example, that ports 64C and 64D are implemented on a single I/O port device (illustrated by dashed line 72). In such a situation, it may not be possible to set the power consumption mode of the ports 64C and 64D differently, or at least significantly differently (e.g., while both ports may operate at different “operable” power consumption modes, may not be possible to turn one port off and leave the second operable). Whether in active-standby or active-active operation, in selecting ports to be turned off (e.g., the illustrative D3 “off” state), the aggregation software 70 may choose to turn off the ports on the same I/O port device 72, which may include moving particular functionality to other ports (e.g., moving the primary and hot standby to ports 64A and 64B respectively). An I/O port device 72 can be powered off if all its ports 64 can be made inactive and set to lower power consumption modes. Doing so results in significant power savings.

Moreover, given that the ports 64 may span different vendors and capabilities, the ports 64 may have varying power consumption for particular utilization. The aggregation software 70, in implementing a particular power policy, may select the most efficient (from a power perspective) port or ports to use for the expected utilization. For example, port 64A and port 64B may have similar peak message packet operations rates, but may differ in power consumption (e.g., a newer hardware device in relation to an older device). Thus, in implementing power policies (including changing power consumption mode to reduce overall power usage by the I/O) the aggregation software may select a device or group of devices that provides the desired functionality at the lowest power consumption. As additional functionality or capacity is needed, less efficient ports may have their power consumption mode raised such that the ports participate, or participate more, in the overall communications. Changing power policy based on parameters associated with particular ports is applicable both in the active-active and active-standby cases.

Still referring to FIG. 2, in accordance with at least some embodiments, the aggregation software 70 is solely responsible for knowing and implementing the power policy of the aggregated I/O for the computer system 100. For example, the aggregation software may, at all times, attempt to implement a power consumption mode for the I/O ports that provides a sufficient amount of bandwidth or throughput capability at the lowest power consumption. However, in at least some embodiments the aggregation software 70 is kernel-level software scheduled for execution frequently and with administrator privileges. However, in some cases power policy decisions need not made as frequently as the aggregation software 70 is scheduled and executed, and thus to reduce the complexity of the aggregation software some embodiments implement a power policy management program 74.

The power policy management program 74 communicates with at least the aggregation software 70, and commands the aggregation software 70 to implement changes in power policy regarding the I/O ports. In a particular embodiment, the power policy management program 74 is a user-level program, and thus runs less frequently and with lower privileges than the aggregation software 70. In some cases the power policy management program 74 is executed within the computer system 100, but in other cases is executed in a different computer system. The power policy management program 74 may, standing alone, make decisions regarding power policy (in some cases based on data received from the aggregation software, such as utilization), or the power policy management program 74 may receive commands from other programs (not specifically shown) and devise particularized policies based on the higher level commands and current state of the computer system 100 as learned from the aggregation software 70.

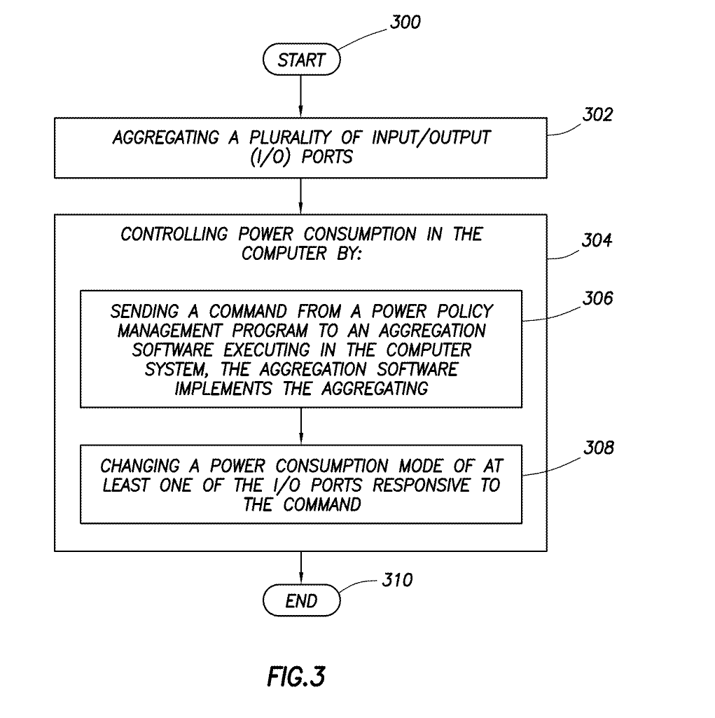

FIG. 3 shows a method (e.g., software) in accordance with at least some embodiments. In particular, the method starts (block 300) and proceeds to: aggregating a plurality of input/output (I/O) ports (block 302); and controlling power consumption in the computer system (block 304). Controlling the power consumption comprises: sending a command from a power policy management program executing in the computer system to an aggregation software also executing in the computer system (block 306), the aggregation software implements the aggregating; and changing a power consumption mode of at least one of the I/O ports responsive to the command (block 308). Thereafter, the method ends (block 310).

From the description provided herein, those skilled in the art are readily able to combine software created as described with appropriate general-purpose or special-purpose computer hardware to create a computer system and/or computer subcomponents in accordance with the various embodiments, to create a computer system and/or computer subcomponents for carrying out the methods of the various embodiments, and/or to create a non-transitory computer-readable storage media for storing software or programs to implement the method aspects of the various embodiments.

The above discussion is meant to be illustrative of the principles and various embodiments of the present invention. Numerous variations and modifications will become apparent to those skilled in the art once the above disclosure is fully appreciated. For example, each component has a maximum number of power cycles, after which the device is likely to fail. The coordinated control discussed herein, in some embodiments, takes into account the number of power cycles of the devices when making decisions regarding the power consumption mode for a device. Moreover, the inventor uses the varying terms “program” and “software” to help the reader distinguish the various functional units of instructions executable by the processor, and not imply that there is fundamental difference (apart from being coded to perform different tasks). In fact, each program and/or software may be written in the same programming language and have many elements that are shared or overlap. It is intended that the following claims be interpreted to embrace all such variations and modifications.

What is claimed is:

1. A method comprising:
aggregating a plurality of input/output (I/O) of a computer system;
controlling power consumption in the computer system by:
sending a command from a power policy management program to an aggregation software executing in the computer system, the aggregation software implements the aggregating; and
changing a power consumption mode of at least one of the plurality of I/O ports responsive to the command.

2. The method of claim 1 further comprising:
wherein sending the command further comprises sending a command to reduce power consumption; and
wherein changing the power consumption mode further comprises changing the power consumption mode of a first I/O port of the plurality of I/O ports from a first power consumption mode with a first peak power state to a second power consumption mode with a second peak power state lower than the first peak power consumption.

3. The method of claim 1 further comprising:
operating a first I/O port of the plurality of I/O ports as primary port, and operating a second and a third I/O ports of the plurality of I/O ports as hot-standby ports; and
wherein changing the power consumption mode further comprises:
changing the power consumption mode of the third I/O port from a first power consumption mode with a first peak power state to a second power consumption mode with a second peak power state lower than the first peak power consumption.

4. The method of claim 3 further comprising:
determining that the first I/O port has experienced a failure; and then
setting the second I/O port as the primary port; and
changing the power consumption mode of the third I/O port to the first power consumption mode.

5. The method of claim 1 further comprising:
operating the plurality of I/O ports such that each I/O port participates in communication with a network to which the computer system couples; and
wherein changing the power consumption mode further comprises:
changing the power consumption mode of the plurality of I/O ports from a first power consumption mode with a first peak power state for each I/O port to a second power consumption mode with a second peak power state for each I/O port different than the first peak power consumption.

6. The method of claim 5 wherein changing the power consumption mode of the I/O ports further comprises at least one selected from the group consisting of: changing to the second peak power consumption mode having a peak power state lower than the first peak power consumption mode; and changing to the second peak power consumption mode having a peak power state higher than the first peak power consumption mode.

7. The method of claim 1 wherein aggregating further comprises aggregating the plurality of I/O ports being at least one selected from the group consisting of: adapter ports configured to communicate with devices across the Internet; and adapter ports configured to communicate with storage devices.

8. A computer system comprising:
a processor;
a plurality of input/output (I/O) adapters coupled to the processor, the I/O adapters configured to couple to a network;
a memory coupled to the processor, the memory stores instructions that, when executed by the processor, cause the processor to:
implement a software stack;
aggregate the plurality of I/O ports;
deliver a command from a power policy management program to an aggregation software that performs the aggregation of the plurality of I/O ports; and
change a power consumption mode of at least one of the plurality of I/O ports responsive to the command.

9. The computer system of claim 8 further comprising:
wherein when the processor delivers the command, the instructions further cause the processor to deliver the command to reduce power consumption mode; and
wherein when the processor changes the power consumption mode, the instructions further cause the processor to change the power consumption mode of a first I/O port of the plurality of I/O ports from a first power consumption mode with a first peak power state to a second power consumption mode with a second peak power state lower than the first peak power state.

10. The computer system of claim 8 further comprising:
wherein, prior to the change in power consumption mode, the computer system operates a first I/O port of the plurality of I/O ports as primary port, operates a second I/O port of the plurality of I/O ports as a hot-standby port, and operates remaining I/O ports of the plurality of I/O ports as hot-standby ports; and
wherein when the processor changes the power consumption mode, the instructions cause the processor to:
change the power consumption mode of the remaining I/O ports from a first power consumption mode with a first peak power state to a second power consumption mode with a second peak power state lower than the first peak power state.

11. The computer system of claim 10 wherein when instructions of the aggregation software further cause the processor to:
determine that the first I/O port has experienced a failure; and then set the second I/O port as the primary port; and
change the power consumption mode of a third I/O port of the plurality of I/O ports to the first power consumption mode.

12. The computer system of claim 8 further comprising:
wherein, prior to the change in power consumption mode, the computer system operates the plurality of I/O ports such that each I/O port participates in communication with the network; and
wherein when the processor changes the power consumption mode, the instructions cause the processor to:
change the power consumption mode of the plurality of I/O ports from a first power consumption mode with a first peak power state for each I/O port to a second power consumption mode with a second peak power state for each I/O port, the second peak power state different than the first peak power state.

13. The computer system of claim 12 wherein when the processor changes the power consumption mode of the plurality of I/O ports, the instructions cause the processor to at least one selected from the group consisting of: change to the second power consumption mode where the second peak power state is lower than the first peak power state; and change to the second power consumption mode where the second peak power state is higher than the first peak power state.

14. The computer system of claim 8 wherein the plurality of I/O ports further comprises at least one selected from the group consisting of: adapter ports configured to communicate across the internet; and adapter ports configured to communicate with storage devices.

15. The computer system of claim 8 wherein the memory is one or more selected from the group consisting of: random access memory (RAM); read only memory (ROM); a hard drive; and an optical drive.

16. A non-transitory computer-readable medium storing instructions that, when executed by a processor, cause the processor to:
aggregate a plurality of I/O ports coupled to the processor;
receive a command from a power policy management program, the command regarding a power policy for the plurality of I/O ports; and
change a power consumption mode of at least one of the plurality of I/O ports responsive to the command.

17. The non-transitory computer-readable medium of claim 16 further comprising:
wherein when the processor aggregates the plurality of I/O ports, the instructions cause the processor to operate a first I/O port of the plurality of I/O ports as a primary port; operate a second I/O port of the plurality of I/O ports as a hot-standby port, and operate remaining I/O ports of the plurality of UO ports as hot-standby ports; and
wherein when the processor changes the power consumption mode, the instructions cause the processor to:
change the power consumption mode of the remaining I/O port from a first power consumption mode with a first peak power state to a second power consumption mode with a second peak power state lower than the first peak power state.

18. The non-transitory computer-readable medium of claim 17 wherein the instructions further cause the processor to:
determine that the first I/O port has experienced a failure; and then set the second I/O port as the primary port; and
change the power consumption mode of a third I/O port of the plurality of I/O ports to the first power consumption mode.

19. The non-transitory computer-readable medium of claim 16 further comprising:
wherein when the processor aggregates the plurality of I/O ports, the instructions cause the processor to operate the plurality of I/O ports such that each I/O port participates in communication with the network; and
wherein when the processor changes the power consumption mode, the instructions cause the processor to:
change the power consumption mode of the plurality of I/O ports from a first power consumption mode with a first peak power state for each I/O port to a second power consumption mode with a second peak power state for each I/O port, the second peak power state different than the first peak power state.

20. The computer system of claim 19 wherein when the processor changes the power consumption mode of the plurality of I/O ports, the instructions cause the processor to at least one selected from the group consisting of: change to the second power consumption mode where the second peak power state is lower than the first peak power state; and change to the second power consumption mode where the second peak power state is higher than the first peak power state.
